(19) United States
(12) Patent Application Publication
(10) Pub. No.: US 2025/0364193 A1
(43) Pub. Date: Nov. 27, 2025

(54) SWITCH DEVICE

(71) Applicant: Alps Alpine Co., Ltd., Tokyo (JP)

(72) Inventor: Takaki TANAKA, Miyagi-ken (JP)

(21) Appl. No.: 19/297,600

(22) Filed: Aug. 12, 2025

Related U.S. Application Data
(63) Continuation of application No. PCT/JP2024/003481, filed on Feb. 2, 2024.

(30) Foreign Application Priority Data
Mar. 17, 2023 (JP) 2023-042471

(51) Int. Cl. H01H 13/14; H01H 13/02

(52) U.S. Cl. CPC H01H 13/14; H01H 13/023

(57) ABSTRACT

A switch device according to an aspect of the invention includes a base provided with a connection terminal to an outside, a switch disposed at the base and connected to the connection terminal, a guide member provided at the base and having a guide face for guiding the switch in a direction of an operation of the switch, a flexible cover covering the switch and the guide member, and a sliding member having a sliding portion held by the flexible cover and sliding on the guide face of the guide member and an operation portion of the switch, thereby enabling a stable operation and good operability, and suppressing damage to the operation portion.

### CLAIM OF PRIORITY

This application is a Continuation of International Application No. PCT/JP2024/003481 filed on Feb. 2, 2024, which claims benefit of Japanese Patent Application No. 2023-042471 filed on Mar. 17, 2023. The entire contents of each application noted above are hereby incorporated by reference.

### BACKGROUND OF THE INVENTION

### 1. Field of the Invention

The present invention relates to a switch device.

### 2. Description of the Related Art

International Publication No. 2021/065648 discloses a switch device including a case formed by primary molding in two-color molding, a switch provided inside the case, a cover member formed by secondary molding in two-color molding using an elastic material, and covering the operation face of the case, and a pressing member formed simultaneously with the case and separated from the case within the opening of the operation face by the first molding process, fixed to the back side of the operation portion of the cover member by the secondary molding, and when a pressing operation is performed on the operation portion, moving toward the switch and pressing the top of the switch.

In a switch device having a configuration where the operation portion of the switch is supported by a cover member, the operation portion tends to tilt in the pressing direction when the operation portion is pressed. When the operation portion tilts, the switch of the operation portion and the contact point will be hit with an angle, causing damage to the operation portion, deterioration of operability, and instability in the switch operation.

The present invention provides a switch device that can achieve a stable operation and good operability, and suppress damage to the operation portion.

### SUMMARY OF THE INVENTION

A switch device related to an aspect of the invention includes a base provided with a connection terminal to an outside, a switch disposed at the base and connected to the connection terminal, a guide member provided at the base and having a guide face for guiding the switch in a direction of an operation of the switch, a flexible cover covering the switch and the guide member, and a sliding member having a sliding portion held by the flexible cover and sliding on the guide face of the guide member and an operation portion of the switch.

With this configuration, the sliding portion held by the flexible cover slides along the guide face of the guide member, thereby suppressing the tilt of the operation portion with respect to the operation direction during the on/off switching operation of the switch and improving operational stability.

It is preferable that, in the above switch device, each of the guide member and the sliding member is made of a resin material having flexibility less than flexibility of the flexible cover. This allows the sliding member to return to its original position by utilizing the flexibility of the flexible cover, and the guide member to stably guide the sliding member.

It is preferable that the above switch device has a regulation structure for regulating displacement of the sliding member toward the base side in the operation direction, and a stop position of the sliding member by the regulation structure is set at a position where the operation portion is located closer to the base than to an on/off switching position of the switch. This prevents the operation portion from being excessively pushed beyond the on/off switching position of the switch.

In the above switch device, the sliding portion may be located at an inner position relative to the guide member, and the sliding member may have a sliding flange portion that contacts a contacted portion, of the guide member, different from the guide face when in the stop position. This causes the sliding member to stop at the stop position by contact between the sliding flange portion provided on the sliding member and the contacted portion, of the guide member, different from the guide face.

In the above switch device, the sliding portion may be located at an outer position relative to the guide member, and the coupling portion connecting the sliding portion and the operation portion may have a sliding contact portion that contacts a contacted portion, of the guide member, different from the guide face at the stop position. As a result, the sliding member stops at the stop position due to the contact between the sliding contact portion provided at the coupling portion connecting the sliding portion and the operation portion and the contacted portion, of the guide member, different from the guide face.

In the above switch device, the guide member may have a hollow tubular portion having an inner wall and an outer wall extending from the base in the operation direction, and the guide face may be formed at one of the inner wall and the outer wall. This guides the sliding portion by means of the guide face provided at one of the inner wall and the outer wall, of the hollow tubular portion, extending from the base in the operation direction. The switch is disposed in a space enclosed by a tubular portion, so that the switch is protected.

The above switch device may include a back portion including the base, the switch, and the guide member, and a front portion including the flexible cover and the sliding members, and the front portion and the back portion may be fixed to each other. As a result, the switch device is configured by fixing the front portion and the back portion together.

The above switch device may include a light emitting unit inside the guide member and a coupling portion, of the sliding member, connecting the sliding portion and the operation portion includes a translucent portion that is allowed to transmit light from the light emitting unit. As a result, light from the light emitting unit is transmitted to the outside through the translucent portion provided at the coupling portion connecting the sliding portion and the operation portion.

In the above switch device, the sliding member may include a first member having the operation portion and a second member having the sliding portion and supported by the flexible cover, and the first member may be fixed to the second member. In this way, the first member is fixed to the second member supported by the flexible cover, so that the sliding member is supported by the flexible cover.

According to the present invention, it is possible to provide a switch device that enables a stable operation, good operability, and suppresses damage to the operation portion.

### BRIEF DESCRIPTION OF THE DRAWINGS

FIG. 1 is a perspective view of a switch device according to the first embodiment;

FIG. 2 is a sectional perspective view of the switch device according to the first embodiment;

FIG. 3 is an exploded perspective view of the switch device according to the first embodiment when viewed from the front side;

FIG. 4 is an exploded perspective view of a switch device according to the first embodiment when viewed from the back side;

FIG. 5 is a sectional view (part 1) showing the operation of the switch device according to the first embodiment;

FIG. 6 is a sectional view (part 2) showing the operation of the switch device according to the first embodiment;

FIG. 7 is a sectional perspective view of a switch device according to the second embodiment;

FIG. 8 is an exploded perspective view of a switch device according to the second embodiment when viewed from the back side;

FIG. 9 is a perspective view of a switch device according to the third embodiment;

FIG. 10 is a sectional perspective view of the switch device according to the third embodiment;

FIG. 11 is a perspective view of a switch device according to the fourth embodiment;

FIG. 12 is a sectional perspective view of the switch device according to the fourth embodiment;

FIG. 13 is an exploded perspective view of a switch device according to the fifth embodiment when viewed from the front side;

FIG. 14 is an exploded perspective view of the switch device according to the fifth embodiment when viewed from the back side;

FIG. 15 is an exploded perspective view of a switch device according to the sixth embodiment when viewed from the front side;

FIG. 16 is an exploded perspective view of the switch device according to the sixth embodiment when viewed from the back side;

FIG. 17 is a perspective view of a switch device according to the seventh embodiment;

FIG. 18 is a perspective view showing the state in which the operation portion of the switch device according to the seventh embodiment is disassembled;

FIG. 19 is a sectional perspective view of the switch device according to the seventh embodiment;

FIG. 20 is a partially enlarged sectional perspective view of the switch device according to the seventh embodiment;

FIG. 21 is a perspective view showing an example of mounting the switch device according to the seventh embodiment;

FIG. 22 is an exploded perspective view showing another example of the operation portion of the switch device according to the seventh embodiment;

FIG. 23 is a sectional perspective view showing another example of mounting of the switch; and

FIG. 24 is a sectional perspective view showing another example of mounting of the switch.

### DESCRIPTION OF THE PREFERRED EMBODIMENTS

### First Embodiment

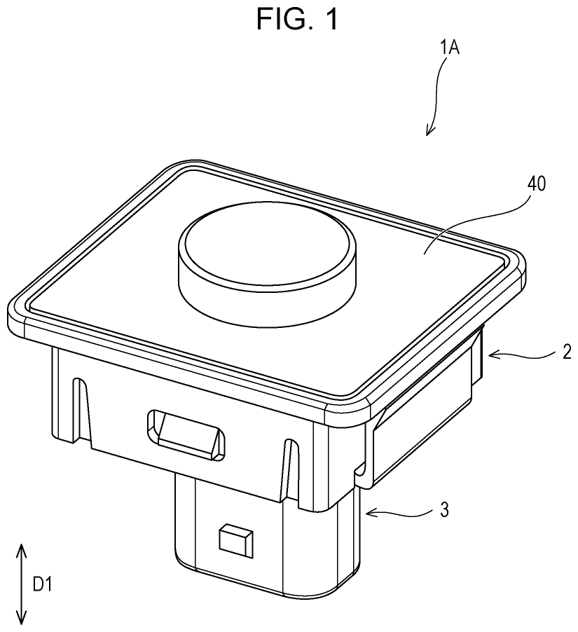

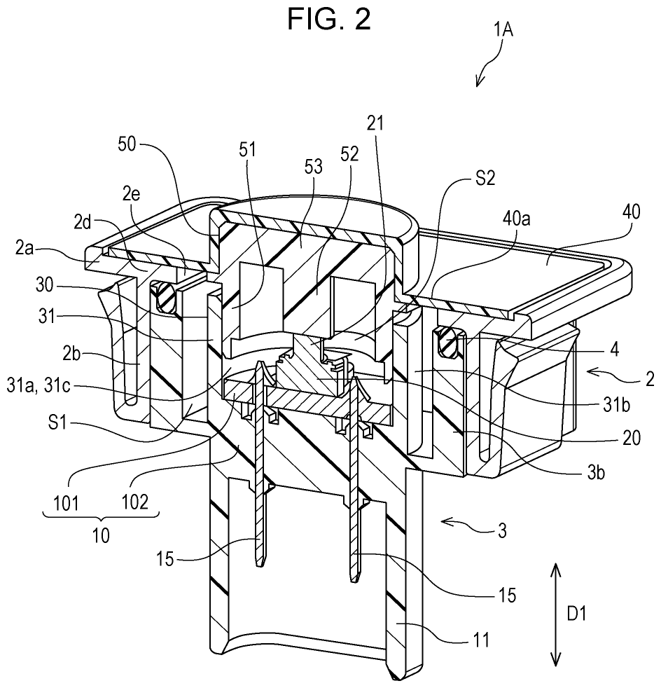

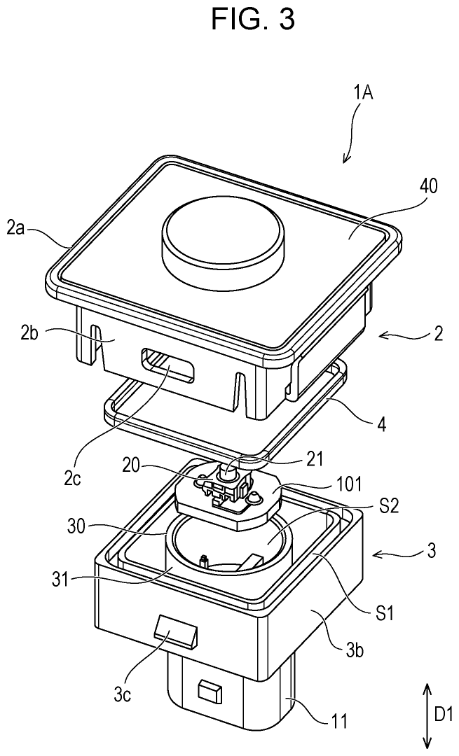

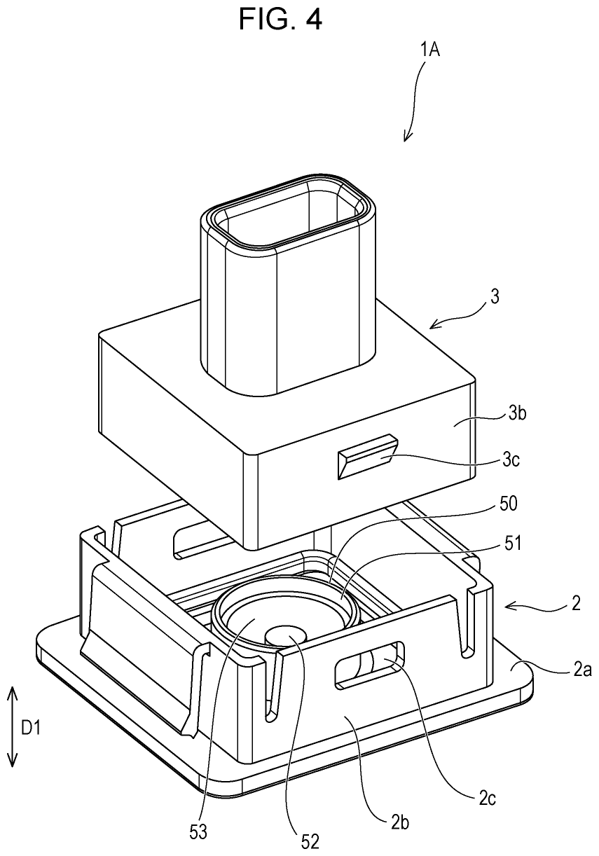

FIG. 1 is a perspective view of a switch device according to the first embodiment. FIG. 2 is a sectional perspective view of the switch device according to the first embodiment. FIG. 3 is an exploded perspective view of the switch device according to the first embodiment when viewed from the front side. FIG. 4 is an exploded perspective view of the switch device according to the first embodiment when viewed from the back side. A switch device 1A according to the first embodiment is a device that is incorporated into a trunk, a back door, a side door, and the like as a switch for electrically unlocking, for example, a trunk, a back door, and the like of a vehicle, or for electrically locking a vehicle side door, and the like.

As shown in FIG. 1, the switch device 1A is provided, for example, in a box shape and covered with a flexible cover 40. For convenience of explanation, a side on which the flexible cover 40 of the switch device 1A is provided is referred to as the front side (upper side), and a side opposite the front side is referred to as the back side (lower side). The switch device 1A has a structure in which a front portion 2 and a back portion 3 are assembled and fixed to each other.

As shown in FIG. 2, the switch device 1A includes a base 10 having a connection terminal 15 to the outside, a switch 20 disposed at the base 10, a guide member 30 having a guide face 31c for guiding the switch 20 in an operation direction D1, a flexible cover 40 covering the switch 20 and the guide member 30, a sliding member 50 having a sliding portion 51 held by the flexible cover 40 and an operation portion 52 of the switch 20.

In the switch device 1A, when the operator presses the operation portion 52, the switch 20 disposed at the base 10 switches to the on state, and the two connection terminals 15 are conductive to each other. On the other hand, when the operator releases the pressing operation, the operation portion 52 returns to the position before pressing, the switch 20 switches to the off state, and the two connection terminals 15 are non-conductive to each other.

In the switch device 1A, the front portion 2 includes the flexible cover 40 and the sliding member 50. The front portion 2 includes a frame body 2a that holds the flexible cover 40, and a first extension portion 2b that extends from the frame body 2a toward the back side direction of the operation direction D1. Here, the frame body 2a has a protrusion 2d that protrudes inward from the outer edge, and the protrusion 2d has an opening that penetrates in the operation direction D1. The sliding member 50 described below is disposed so as to be movable in this opening in the operation direction D1. The flexible cover 40 is held by the protrusion 2d of the frame body 2a. In addition, the first extension portion 2b is disposed at a position spaced outward from an opening inner edge 2e of the frame body 2a, that is, the protrusion 2d of the frame body 2a protrudes inward relative to the inner circumference of the first extension portion 2b. On the other hand, the back portion 3 includes the base 10, the switch 20, and the guide member 30. The back portion 3 has a second extension portion 3b extending toward the front side direction of the operation direction D1 from the base 10. The first extension portion 2b of the front portion 2 and the second extension portion 3b of the back portion 3 are combined to face each other, thereby forming the box body. Here, at least a portion of the first extension portion 2b may be combined so as to be located at the circumference of the second extension portion 3b, or at least a portion of the second extension portion 3b may be combined so as to be located at the circumference of the first extension portion 2b.

In the assembly of the front portion 2 and the back portion 3, the first extension portion 2b and the second extension portion 3b have overlapping portions that overlap each other when viewed in a direction perpendicular to the operation direction D1, and the first extension portion 2b and the second extension portion 3b may have a structure in which they engage with each other at the overlapping portions. An example of the engagement in the overlapping portions includes an engagement of a hole 2c provided in the first extension portion 2b and a projection 3c provided at the second extension portion 3b, as shown in FIGS. 3 and 4. In addition, the front portion 2 and the back portion 3 may be assembled by adhesive bonding. When assembling the front portion 2 and the back portion 3, it is preferable to provide a sealing member 4 between them to ensure sealability. In this case, it is preferable to dispose the upper end face of the second extension portion 3b to face the back side of the protrusion 2d of the frame body 2a and to compress and sandwich the sealing member 4 by the two members. In addition, the first extension portion 2b is formed so as to be aligned with each other by utilizing the inner circumference or the outer circumference of the second extension portion 3b, thereby ensuring ease of assembly and sealability.

In the switch device 1A, the base 10 has a substrate 101 on which the switch 20 is mounted and a pedestal 102 on which the substrate 101 is disposed. The connection terminals 15 are provided so as to pass through the pedestal 102, with one of the connection terminals 15 connected (for example, soldered) to a conductive pattern provided on the substrate 101, and the other extending toward the back side of the pedestal 102. The base 10 has a tubular portion 11 extending toward the back side therefrom, and two connection terminals 15 extending from the pedestal 102 toward the back side protrude into the tubular portion 11 in a substantially parallel manner. The tubular portion 11 may be used as a female connector.

The switch 20 is, for example, a push switch, and the conductive state is switched by pressing/not pressing a movable portion 21. The guide member 30 extending upward from the pedestal 102, for example, in a tubular shape is provided around the substrate 101 on which the switch 20 is mounted.

The guide member 30 is provided independently of the second extension portion 3b of the back portion 3 from the base 10, and a space S1 is formed between the second extension portion 3b and the guide member 30. The space S1 is provided around the guide member 30, so that even when water, moisture, foreign matter, and the like from the outside enter the space, they are retained within the space S1, thereby effectively protecting the switch 20 from them.

The guide member 30 may be a portion of the second extension portion 3b. In this case, the second extension portion 3b and the guide member 30 are shared, thereby simplifying and miniaturizing the structure of the back portion 3.

A tubular portion 31 of the guide member 30 has an inner wall 31a and an outer wall 31b extending in the operation direction D1. One of the inner wall 31a and the outer wall 31b is the guide face 31c for guiding the switch 20 in the operation direction D1. In the present embodiment, a portion of the inner wall 31a is the guide face 31c. Here, the guide member 30 has an upper end face 30a lower than the protrusion 2d, of the frame body 2a, close to the opening inner edge 2e, thereby forming an area for movement of the sliding member 50 described later in the operation direction D1.

The switch 20 is disposed in a space S2 surrounded by the tubular portion 31 on the substrate 101. The switch 20 is disposed in the space S2 surrounded by the tubular portion 31, so that the switch 20 can be effectively protected.

Furthermore, it is preferable that the switch 20 is accommodated in a closed space including the first extension portion 2b of the front portion 2, the second extension portion 3b of the back portion 3, the base 10, and the flexible cover 40. By assembling and fixing the front portion 2 and the back portion 3, the space S2 is a closed space, thereby further enhancing the waterproof and dustproof properties of the space S2 in which the switch 20 is disposed.

The sliding member 50 is disposed in an opening formed in the protrusion 2d of the frame body 2a, and includes the sliding portion 51 that is held by the flexible cover 40 and slides on the guide face 31c of the guide member 30, and the operation portion 52 of the switch 20. The sliding portion 51 extends downward in a tubular shape, for example, and is inserted inside the guide member 30 and is provided so as to be slidable along the guide face 31c. The sliding portion 51 may be fitted with the outside of the guide member 30.

The operation portion 52 is disposed above the movable portion 21 of the switch 20. In the sliding member 50, the sliding portion 51 and the operation portion 52 are coupled by a coupling portion 53. The coupling portion 53 corresponds to the top plate portion of the sliding member 50. The front portion of the coupling portion 53 is used as an operation button. The operation portion 52 extends downward from the lower central portion of the coupling portion 53, and the sliding portion 51 extends downward from the lower peripheral portion of the coupling portion 53.

The sliding portion 51 of the sliding member 50 slides along the guide face 31c of the guide member 30, thereby guiding the sliding motion of the sliding member 50 in the operation direction D1. By pressing the sliding member 50 downward, the operation portion 52 presses the movable portion 21 of the switch 20 to operate the switch 20.

The flexible cover 40 is connected to the upper face of the protrusion 2d of the frame body 2a of the front portion 2 and is provided so as to cover the coupling portion 53 of the sliding member 50 from above. The flexible cover 40 is made of an elastic material (for example, elastomer). On the other hand, the guide member 30 and the sliding member 50 are made of a resin material having flexibility less than flexibility of the flexible cover 40. This makes it possible to use the flexibility of the flexible cover 40 to help the sliding member 50 return to its original position, and the guide member 30 to guide the sliding member 50 smoothly.

The flexible cover 40 is integrally formed with the frame body 2a and the sliding member 50 by secondary molding using two-color molding with the flexible cover 40 made of a material different from that of the frame body 2a and the sliding member 50. Therefore, the frame body 2a, the first extension portion 2b, the flexible cover 40, and the sliding member 50 that constitute the front portion 2 are integrally formed, and the sliding member 50 is supported by the frame body 2a with the flexible cover 40. Here, to explain in more detail, the flexible cover 40 is fixed to the frame body 2a at the fixed position between the outer edge of the protrusion 2d of the frame body 2a and the opening inner edge 2e, and a flange portion 40a located between the fixed portions of the sliding member 50 is a movable portion.

Furthermore, in the initial state where no pressing force is applied, the sliding member 50 is supported so as to be lifted upward in the operation direction D1 by the flange portion 40a, which is the movable portion of the flexible cover 40, and is away from the upper end face 30a of the guide member 30.

When a downward pressing force in the operation direction D1 is applied to the sliding member 50, the flange portion 40a, which is the movable portion of the flexible cover 40, elastically deforms, allowing movement toward the upper end face 30a of the guide member 30. When the pressing force on the sliding member 50 is released, the elastic force of the flange portion 40a, which is the movable portion of the flexible cover 40, helps the sliding member 50 move in the return direction.

Furthermore, it is possible to provide an arcuate portion on the flange portion 40a, which is the movable portion of the flexible cover 40, to increase the amount of lifting upward in the operation direction D1, thereby increasing the amount of movement. In this case, it is possible to set the upper limit of the amount of movement of the sliding member 50 above the protrusion 2d of the frame body 2a, thereby ensuring the operation amount without changing the overall size of the switch device.

By assembling the front portion 2 and the back portion 3, the sliding portion 51 of the sliding member 50 is inserted into the tubular portion 31 of the guide member 30, thereby regulating the movement of the sliding member 50 in a direction intersecting the operation direction D1 and in a direction inclined with respect to the operation direction D1.

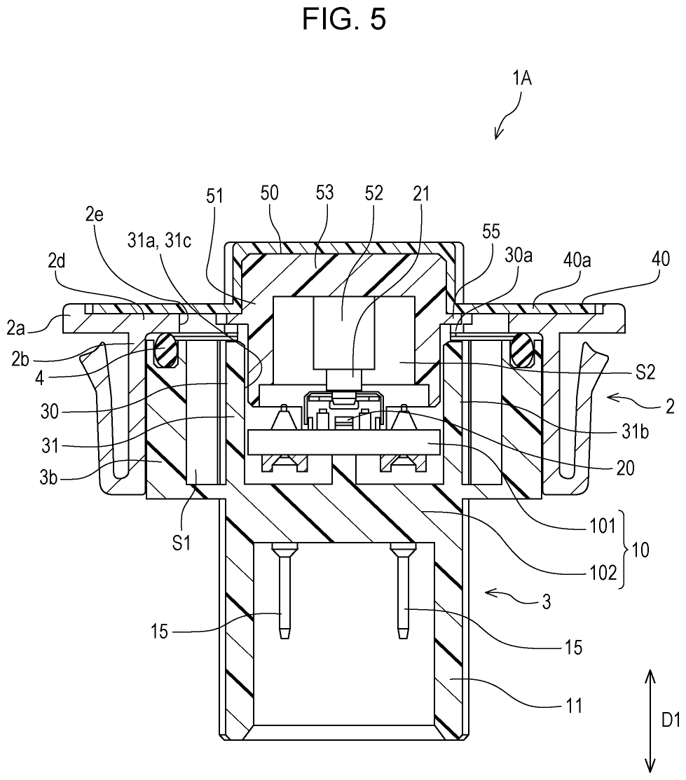

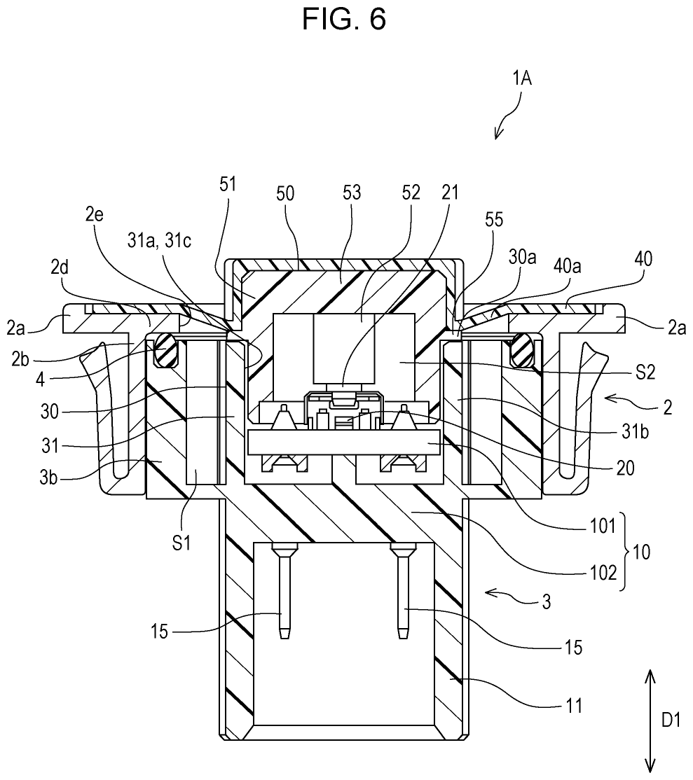

FIG. 5 is a sectional view (part 1) showing the operation of the switch device according to the first embodiment. FIG. 6 is a sectional view (part 2) showing the operation of the switch device according to the first embodiment. As shown in FIG. 5, in the initial state where no pressing force is applied to the operation portion 52 of the switch device 1A, the sliding member 50 supported by the flexible cover 40 is at the reference position (return position) due to the elastic force (restoring force) of the flexible cover 40, and no pressing force is applied from the operation portion 52 to the movable portion 21. The switch 20 is provided with a biasing means (for example, a spring, not shown), and the movable portion 21 is pushed upward by the biasing force of the biasing means. As a result, the switch 20 is turned off, for example, in the case of a normally open switch (or turned on in the case of a normally closed switch).

As shown in FIG. 6, when the pressing force is applied to the operation portion 52 of the switch device 1A, the sliding member 50 is pushed downward by the elastic deformation of the flexible cover 40. The sliding member 50 moves downward in the operation direction D1 by sliding of the sliding portion 51 along the guide face 31c. When a pressing force exceeding the biasing force of the biasing means of the switch 20 is applied to the movable portion 21, the movable portion 21 is pushed down. When the position of the movable portion 21 passes the on-off switching position, the switch 20 is turned on, for example, in the case of a normally open switch (or turned off in the case of a normally closed switch).

When the pressing force on the operation portion 52 of the switch device 1A is released, the movable portion 21 is pushed upward by the biasing force of the biasing means of the switch 20, and the sliding member 50 is pushed upward. When the position of the movable portion 21 passes the on-off switching position, the switch 20 is turned off, for example, in the case of a normally open switch (or turned on in the case of a normally closed switch). Furthermore, the sliding member 50 is returned to the reference position (return position) by the elastic force (restoring force) of the flexible cover 40, thereby returning to the initial state.

In the operation of such a switch device 1A, the sliding portion 51 held by the flexible cover 40 slides along the guide face 31c of the guide member 30. For example, since the tubular sliding portion 51 is inserted inside the tubular portion 31 extending in the operation direction D1, the tubular sliding portion 51 slides stably in the operation direction D1 with the inner wall 31a of the tubular portion 31 as the guide face 31c. Therefore, even when the sliding member 50 is supported by the flexible cover 40, the tilt of the operation portion 52 with respect to the operation direction D1 is suppressed during the on/off switching operation of the switch 20, thereby improving the stability of the operation. Furthermore, when the sliding portion 51 is fitted with the outside of the tubular portion 31, a portion of the outer wall 31b of the tubular portion 31 is the guide face 31c.

Furthermore, since the sliding member 50 slides without tilting with respect to the operation direction D1, good operability can be obtained in the on/off switching operation of the switch 20. Furthermore, since the tilt of the sliding member 50 during the sliding motion is suppressed, the operation portion 52 comes into straight contact with the movable portion 21 of the switch 20 (without coming into oblique contact), thereby suppressing damage to the operation portion 52 and the movable portion 21.

It is preferable that the switch device 1A has a regulation structure that regulates displacement of the sliding member 50 toward the base 10 in the operation direction D1. The regulation structure of the switch device 1A has a sliding flange portion 55 provided on the sliding member 50. The sliding portion 51 is located at an inner position relative to the guide member 30, and the sliding flange portion 55 is provided as a projection portion extending outwardly from the outer circumference of the sliding portion 51. The sliding flange portion 55 comes into contact with a contacted portion (for example, the upper end face 30a of the guide member 30) that is different from the guide face 31c of the sliding portion 51. In this case, the upper end face 30a of the guide member 30 is formed lower than the protrusion 2d, of the frame body 2a, close to the opening inner edge 2e, thereby forming a region for movement of the sliding flange portion 55 of the sliding member 50 in the operation direction D1.

When the sliding member 50 is pushed down, further downward sliding of the sliding member 50 is regulated at the position where the sliding flange portion 55 and the upper end face 30a of the guide member 30 come into contact. By regulating the downward position of the sliding member 50 by the regulation structure, the excessive pressing force on the switch 20 can be suppressed. Here, it is preferable that the stop position of the sliding member 50 by the regulation structure be set at a position where the operation portion 52 is located closer to the base 10 than to the on/off switching position of the switch 20. With this configuration, it is possible for the operation portion 52 to reliably perform the switching operation after passing the on/off switching position of the switch 20, and also prevents the excessive load from being applied to the switch 20 due to further pushing.

### Second Embodiment

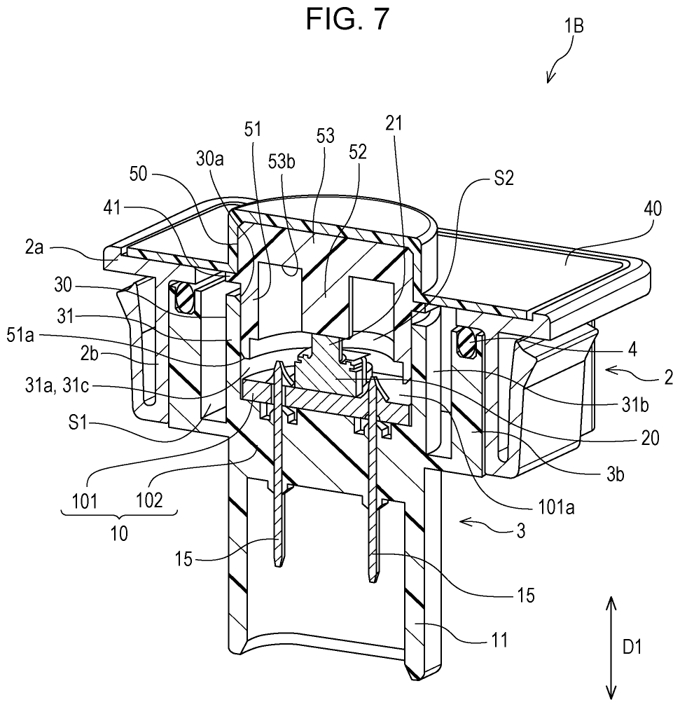

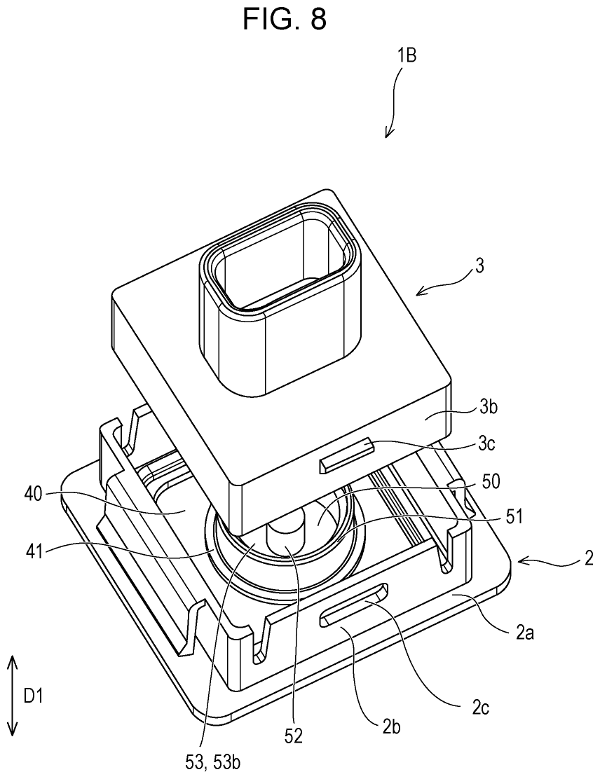

FIG. 7 is a sectional perspective view of a switch device according to the second embodiment. FIG. 8 is an exploded perspective view of the switch device according to the second embodiment when viewed from the back side. A switch device 1B according to the second embodiment is different from the switch device 1A according to the first embodiment in the regulation structure. The regulation structure of the switch device 1B has a cover contact portion 41 that protrudes downward from the back face of the flexible cover 40.

In the switch device 1B, the sliding portion 51 is located at an inner position relative to the guide member 30, and the cover contact portion 41 is provided so as to protrude downward facing the tubular portion 31 of the guide member 30 along the outer circumferential face of the sliding portion 51. It is preferable that the cover contact portion 41 is provided around the entire outer circumferential face of the sliding portion 51, but may be partially provided.

The cover contact portion 41 is configured to come into contact with the guide member 30 at the position (stop position) where the pressed sliding member 50 stops. In the present embodiment, the cover contact portion 41 contacts the upper end face 30a of the guide member 30. This prevents the operation portion 52 from being excessively pushed in beyond the on/off switching position of the switch 20. In addition, the cover contact portion 41 is a portion of the flexible cover 40 and is therefore more flexible than the guide member 30. This makes it possible to mitigate the impact on the guide member 30 when the cover contact portion 41 comes into contact with the upper end face 30a of the guide member 30, thereby enabling reduction of operation noise and adjustment of operability.

The regulation structure may be different from the configuration described in each of the switch device 1A of the first embodiment and the switch device 1B of the second embodiment. For example, when the sliding member 50 is pushed down, the structure may be such that the sliding member 50 is prevented from sliding downward by bringing a lower end face 51a of the sliding portion 51 into contact with an upper face 101a of the base 10 (for example, the substrate 101).

In addition, in a structure where the sliding portion 51 is located at an outer position relative to the guide member 30 (for example, a structure where the tubular sliding portion 51 is fitted with the outside of the tubular portion 31), the sliding contact portion may be provided in the coupling portion 53 as a regulation structure. For example, when the sliding member 50 is pushed down, the structure may be such that the sliding member 50 is prevented from sliding downward by bringing a back face 53b of the coupling portion 53 into contact with the upper end face 30a of the guide member 30. In this case, the back face 53b of the coupling portion 53 is the sliding contact portion, and the upper end face 30a of the guide member 30 is the contacted portion.

In addition, as a regulation structure, the guide member 30 may have a guide flange portion. The guide flange portion contacts the sliding member 50 at the stop position of the sliding member 50. The guide flange portion may come into contact with the sliding member 50 via a portion of the flexible cover 40.

### Third Embodiment

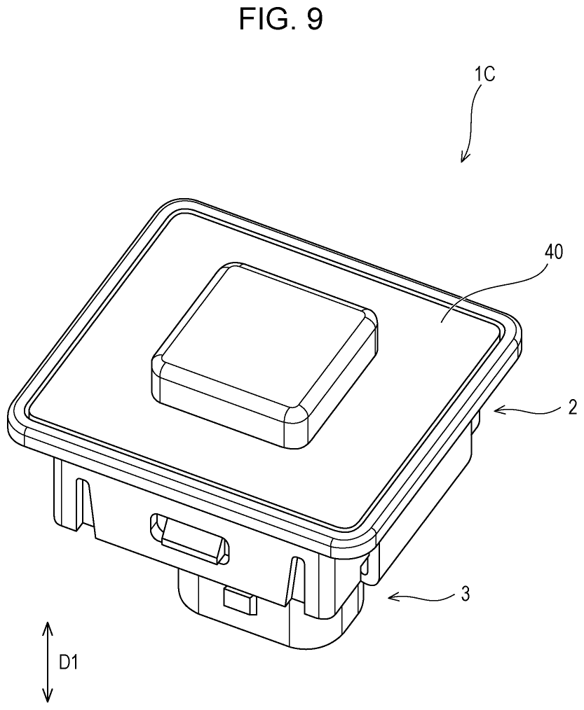

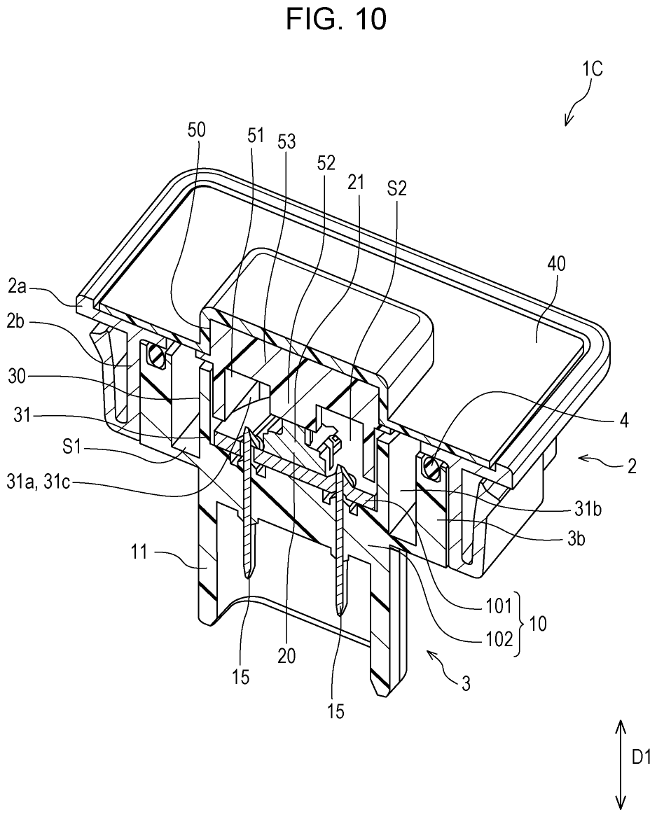

FIG. 9 is a perspective view of a switch device according to the third embodiment. FIG. 10 is a sectional perspective view showing the switch device according to the third embodiment. A switch device 1C according to the third embodiment is different from the switch device 1A according to the first embodiment in the shape of the coupling portion 53 of the sliding member 50. That is, the switch device 1C according to the third embodiment includes the coupling portion 53 having a prismatic shape.

The flexible cover 40 is integrally formed with the frame body 2a and the sliding member 50 by secondary molding using two-color molding with the flexible cover 40 made of a material different from that of the frame body 2a and the sliding member 50. Since the flexible cover 40 is made of an elastic material (for example, elastomer), the flexible cover 40 is in close contact with the surface of the angular columnar coupling portion 53 so as to cover the surface of the coupling portion 53 by two-color molding.

By implementing two-color molding with the elastic material, the flexible cover 40 can be in close contact with the coupling portion 53 even if its shape is not prismatic, so that the design freedom of the protruding shape of the coupling portion 53 is increased according to the aspect of the product.

### Fourth Embodiment

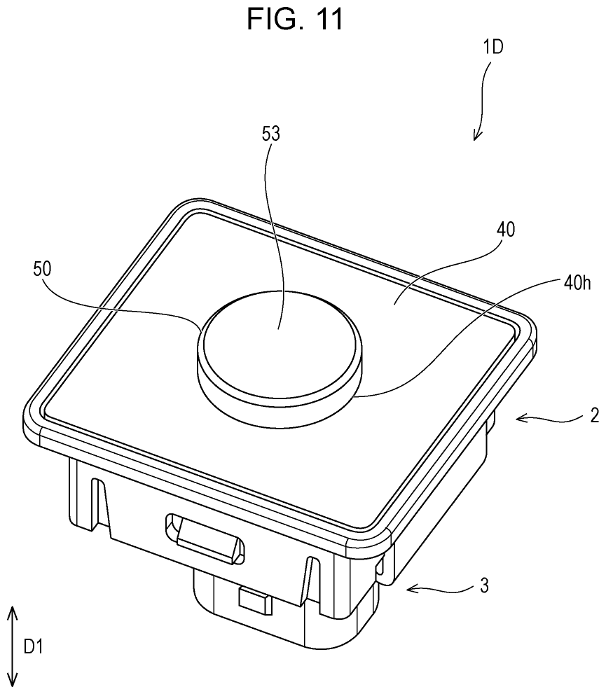

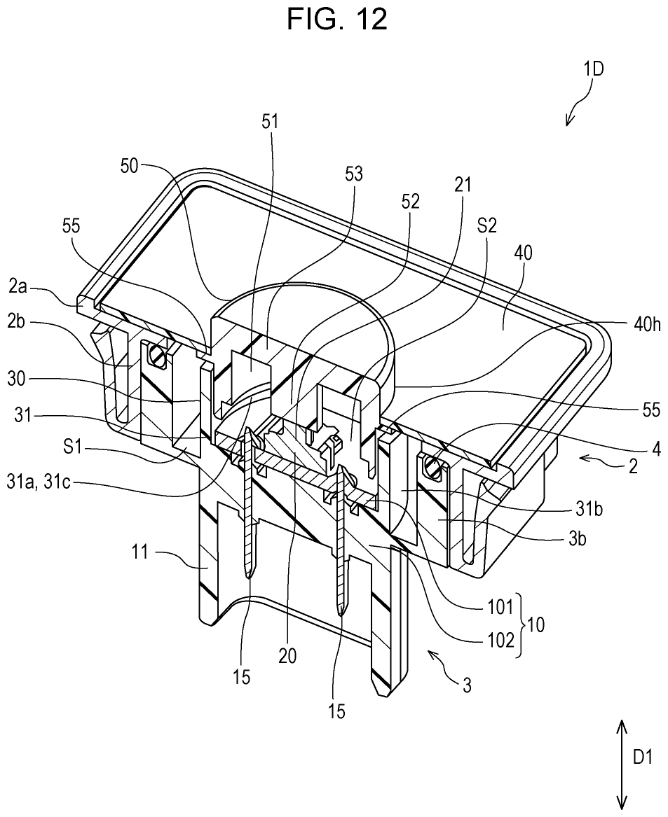

FIG. 11 is a perspective view of a switch device according to the fourth embodiment. FIG. 12 is a sectional perspective view of the switch device according to the fourth embodiment. A switch device 1D according to the fourth embodiment has a configuration in which the surface of the coupling portion 53 of the sliding member 50 is exposed from the flexible cover 40. The flexible cover 40 has a hole 40h at the central portion thereof, and the coupling portion 53 of the sliding member 50 is provided so as to protrude from the hole 40h. In this configuration, the flexible cover 40 is provided so as to cover at least a portion of an end of the sliding member 50, the end being opposite to a portion, of the sliding member 50, facing the switch 20 in the operation direction D1. For example, the flexible cover 40 is in close contact with the surface of, for example, the sliding flange portion 55 of the sliding member 50.

Since the surface of the coupling portion 53 is exposed from the flexible cover 40, the protrusion of the coupling portion 53 can be made into an operation button portion of the switch device 1D, thereby enhancing the design and the design freedom of the operation button portion.

### Fifth Embodiment

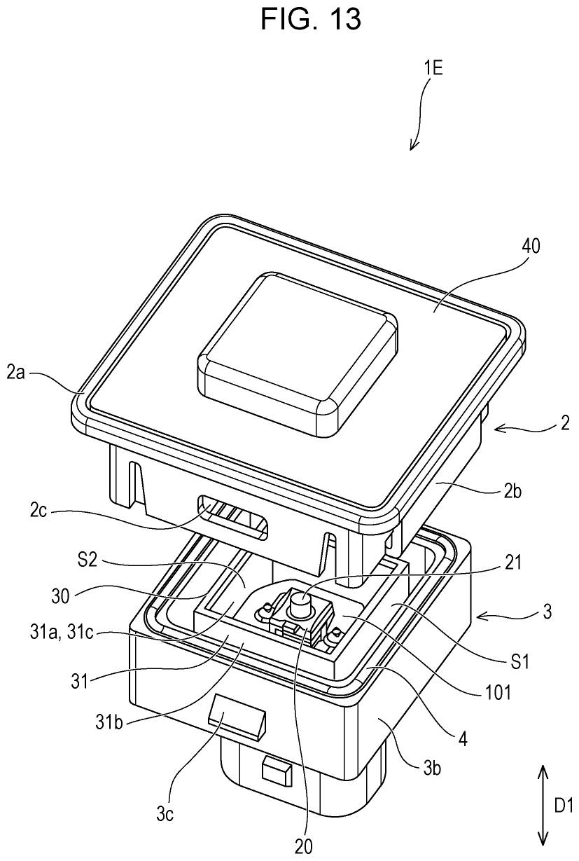

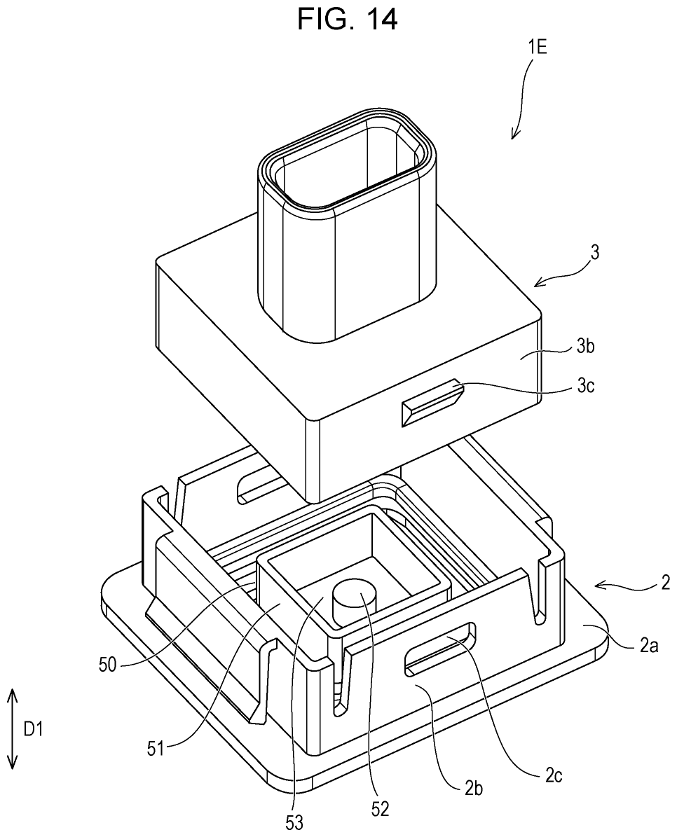

FIG. 13 is an exploded perspective view of a switch device according to the fifth embodiment when viewed from the front side. FIG. 14 is an exploded perspective view of the switch device according to the fifth embodiment when viewed from the back side. A switch device 1E according to the fifth embodiment is different from the switch device 1A according to the first embodiment in the shape of the tubular portion 31 of the guide member 30. That is, the switch device 1E according to the fifth embodiment includes the tubular portion 31, of the guide member 30, having an angular tubular shape. In addition, in the switch device 1E, the sliding portion 51 of the sliding member 50 has an angular tubular shape in association with the angular tubular guide member 30.

The guide member 30 has the guide face 31c parallel to the operation direction D1. The guide face 31c may be flat. In the switch device 1E, one of the inner wall 31a and the outer wall 31b of the angular tubular guide member 30 is made into the guide face 31c.

Note that the outer circumference of each of the guide member 30 and the sliding portion 51 does not need to be closed, but closing them allows the space accommodating the switch 20 to be made into a closed space, thereby effectively protecting the switch 20 from the entry of moisture, humidity, foreign matter, and the like.

### Sixth Embodiment

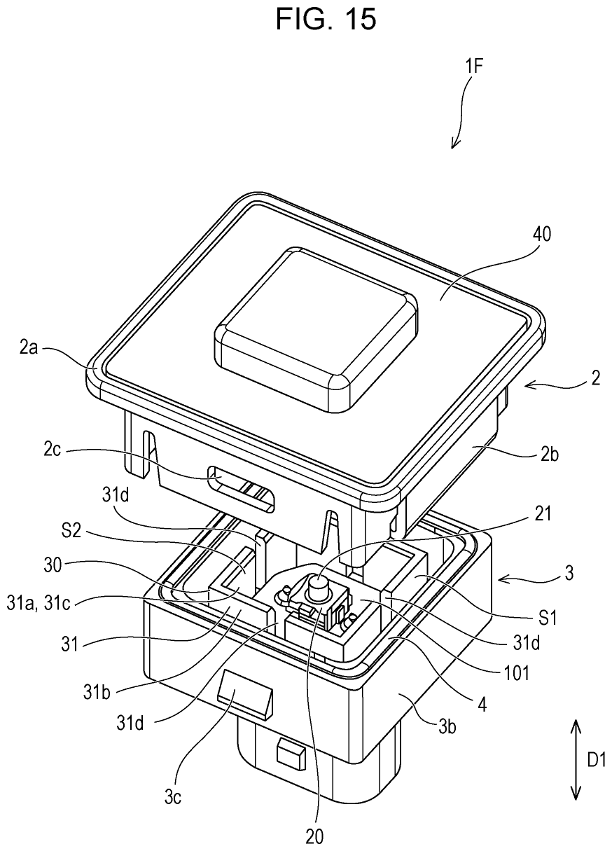

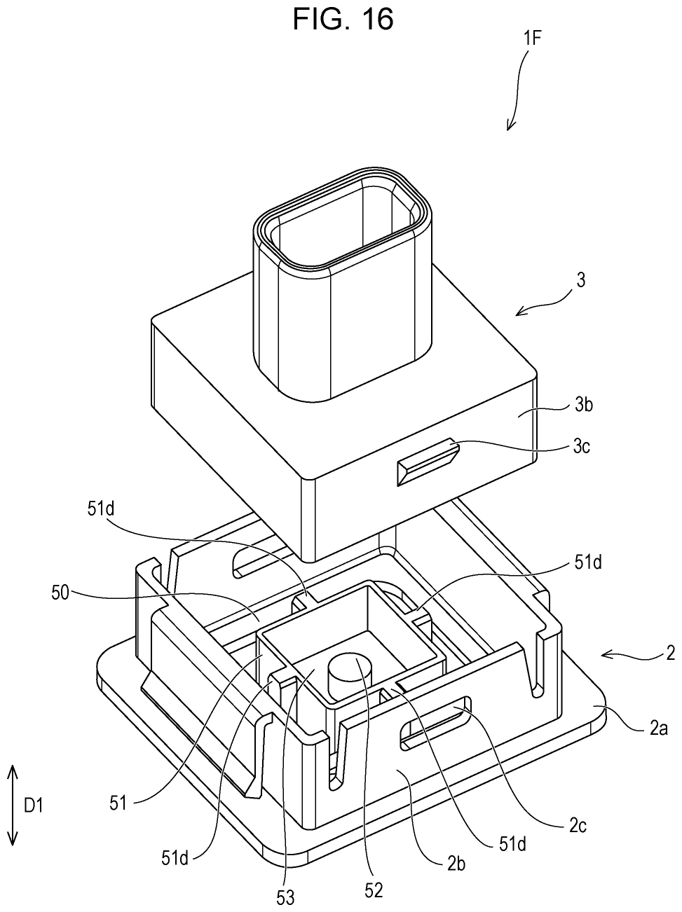

FIG. 15 is an exploded perspective view of a switch device according to the sixth embodiment when viewed from the front side. FIG. 16 is an exploded perspective view of the switch device according to the sixth embodiment when viewed from the back side. A switch device 1F according to the sixth embodiment is different from the switch device 1A according to the first embodiment in the shape of the tubular portion 31 of the guide member 30 and the shape of the sliding portion 51 of the sliding member 50. That is, in the switch device IF according to the sixth embodiment, the tubular portion 31 of the guide member 30 has a slit 31d extending in the operation direction D1. For example, the tubular portion 31 has a plurality of slits 31d. In addition, the sliding portion 51 of the sliding member 50 has a projection portion 51d extending in the operation direction D1 in association with the slit 31d of the tubular portion 31.

When combining the front portion 2 and the back portion 3, the projection portion 51d of the sliding portion 51 is fitted into the slit 31d of the tubular portion 31 of the guide member 30. With this configuration, the change in the relative position of the projection portion 51d and the slit 31d is regulated to a direction in which the slit 31d extends. Therefore, the sliding direction of the sliding member 50 is regulated to the direction in which the slit 31d extends, that is, the operation direction D1.

Note that, in the above description, the tubular portion 31 of the guide member 30 has the slit 31d, and the sliding portion 51 of the sliding member 50 has the projection portion 51d, but the configuration may be such that the tubular portion 31 has a projection portion, and the sliding portion 51 has the slit that engages with the projection portion.

### Seventh Embodiment

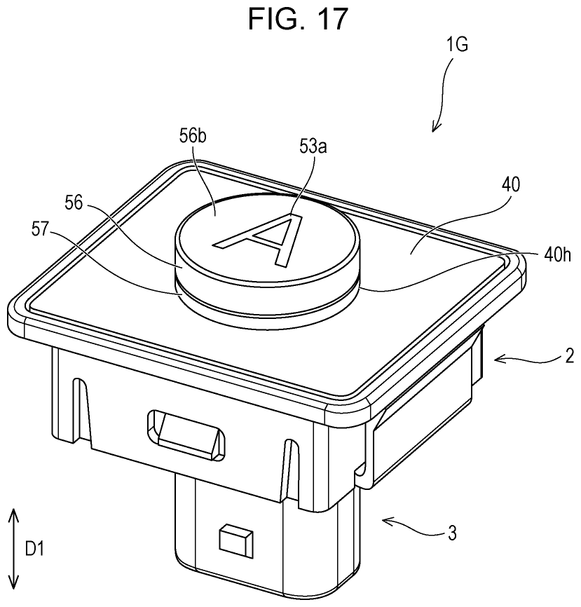

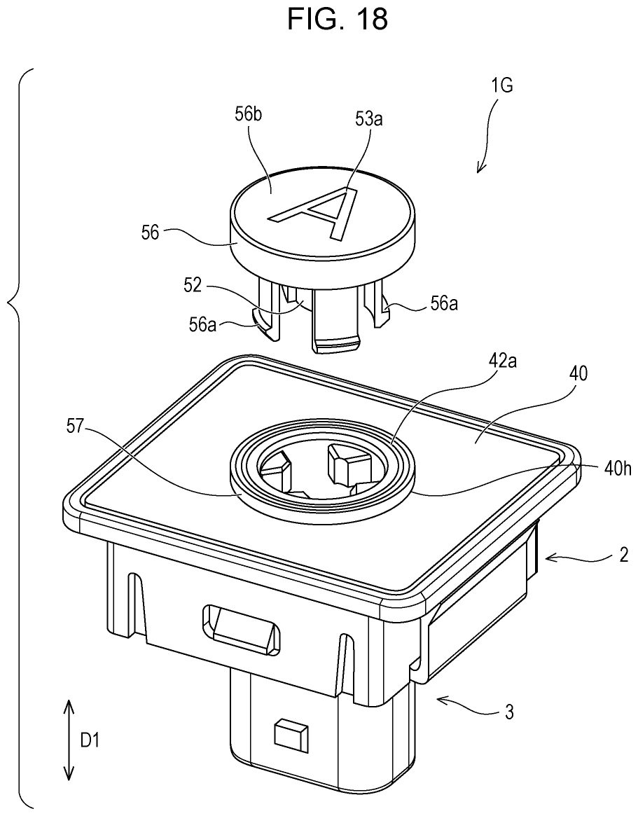

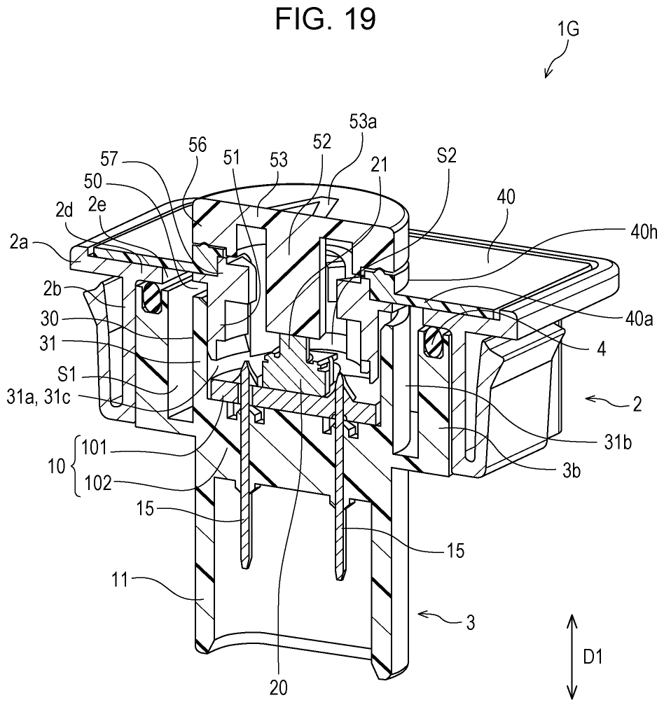

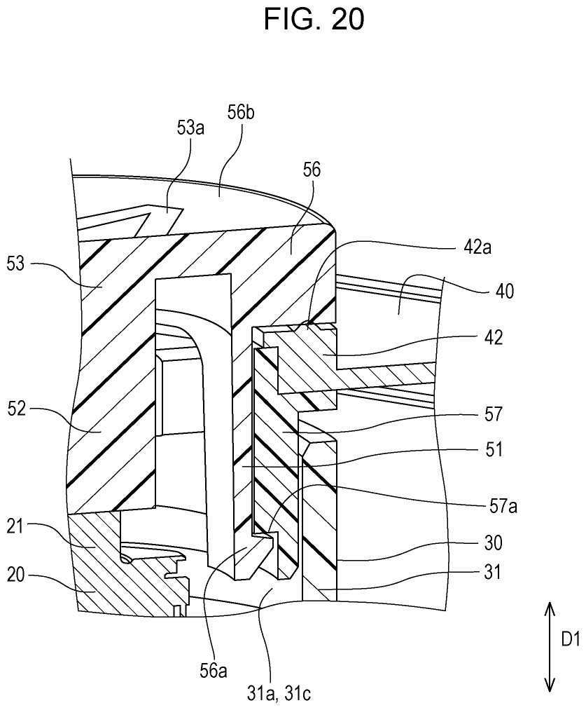

FIG. 17 is a perspective view of a switch device according to the seventh embodiment. FIG. 18 is a perspective view showing the state in which the operation portion of the switch device according to the seventh embodiment is disassembled. FIG. 19 is a sectional perspective view of the switch device according to the seventh embodiment. FIG. 20 is a partially enlarged sectional perspective view of the switch device according to the seventh embodiment.

In a switch device 1G according to the seventh embodiment, the sliding member 50 includes a first member 56 having the operation portion 52 and a second member 57 having the sliding portion 51 and supported by the flexible cover 40. That is, the sliding member 50 is divided into the first member 56 and the second member 57. The first member 56 is fixed to the second member 57. For example, the first member 56 has a claw portion 56a, and the second member 57 has a step portion 57a on which the claw portion 56a can be hooked. The first member 56 and the second member 57 are fixed by engagement when the claw portion 56a is hooked onto the step portion 57a.

The first member 56 is connected to the operation portion 52 and has a knob portion 56b exposed from the flexible cover 40. On the other hand, the second member 57 is provided so as to be in close contact with the flexible cover 40 along the edge of the hole 40h provided in the central portion of the flexible cover 40. The second member 57 is formed in a tubular shape, and the first member 56 is fitted into the tube of the second member 57. That the first member 56 having the knob portion 56b is separated from the second member 57 increases the design freedom of the shape, the material, the color, and the like of the knob portion 56b operated by the user.

The edge portion of the hole 40h of the flexible cover 40 has an intermediate portion 42 which is sandwiched between the first member 56 and the second member 57 when the first member 56 is fitted into the tube of the second member 57. The intermediate portion 42 has an annular rib 42a. When the first member 56 is fitted into the tube of the second member 57, the annular rib 42a is compressed in the operation direction D1 and is sandwiched between the first member 56 and the second member 57. The annular rib 42a is provided, so that sealability (waterproofing, etc.) between the first member 56 and the second member 57 is enhanced.

The switch device 1G may include a light emitting unit (not shown) inside the guide member 30. The light emitting unit is mounted on, for example, the substrate 101. In addition, in a configuration with the light emitting unit, a translucent portion 53a may be provided at the exposed portion, of the coupling portion 53 of the sliding member 50, not covered by the flexible cover 40. This allows light from the light emitting unit to pass through the translucent portion 53a to the outside from the exposed portion and to be visible from the outside.

For example, when the knob portion 56b of the first member 56 having the coupling portion 53 has the translucent portion 53a with predetermined characters or patterns, it is possible to form a design in which light from the light emitting unit passes through the translucent portion 53a so that the characters or patterns appear to be illuminated. In addition, the entire first member 56 may be made translucent. In this case, the entire first member 56 (for example, the knob portion 56b) can transmit light from the light emitting unit.

Furthermore, when the coupling portion 53 has the translucent portion 53a and the coupling portion 53 is covered by the flexible cover 40, at least part of a portion of the flexible cover 40, the portion covering the translucent portion 53a, may be made translucent. In addition, the light emission by the light emitting unit may be constantly turned on, or may be switched between turned-on and turned-off in conjunction with the operation of the switch 20, for example.

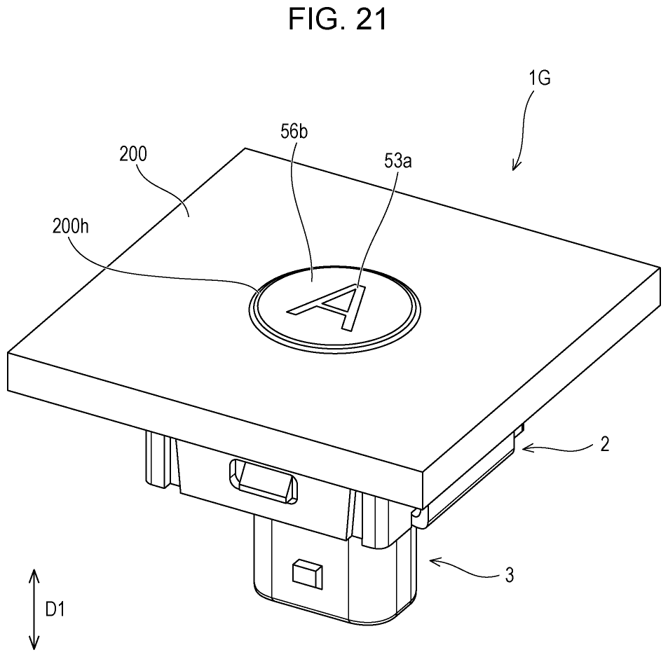

FIG. 21 is a perspective view showing an example of mounting the switch device according to the seventh embodiment. The switch device 1G is mounted on the back face of a panel material 200, for example. The panel material 200 has a hole 200h, and the knob portion 56b of the switch device 1G is exposed from the hole 200h, so that a portion other than the knob portion 56b is hidden by the panel material 200. When operating, the switch device 1G can be turned on and off by pressing down the knob portion 56b exposed from the hole 200h of the panel material 200.

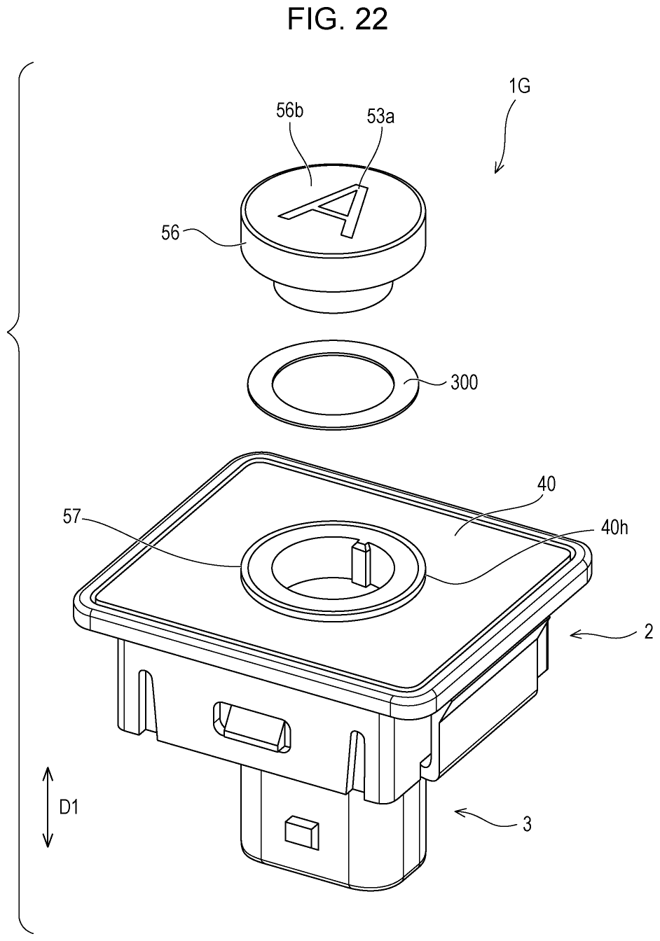

FIG. 22 is an exploded perspective view showing another example of the operation portion of the switch device according to the seventh embodiment. In the switch device 1G, the way of fixing the first member 56 to the second member 57 may be other than an engagement. For example, as shown in FIG. 22, the first member 56 may be fixed to the second member 57 using a double-sided tape 300. In addition, the first member 56 may be fixed to the second member 57 by an adhesive.

### <Other Examples of Connection Terminal>

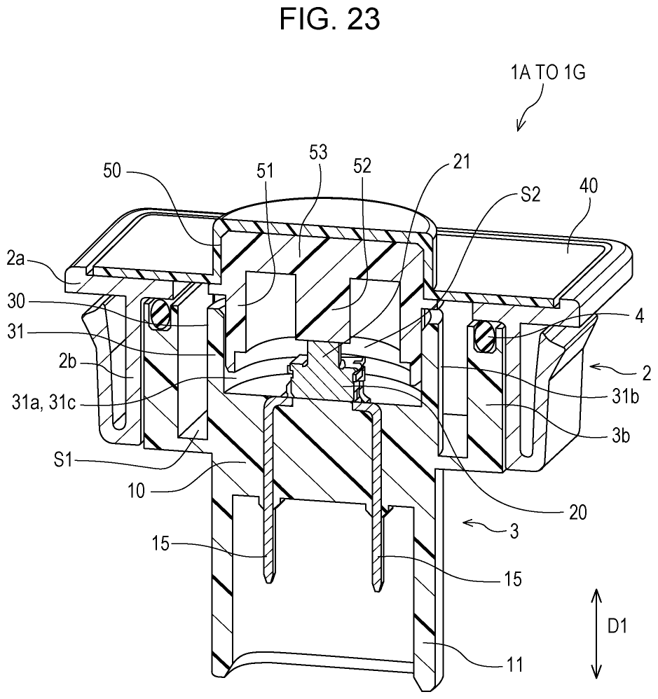

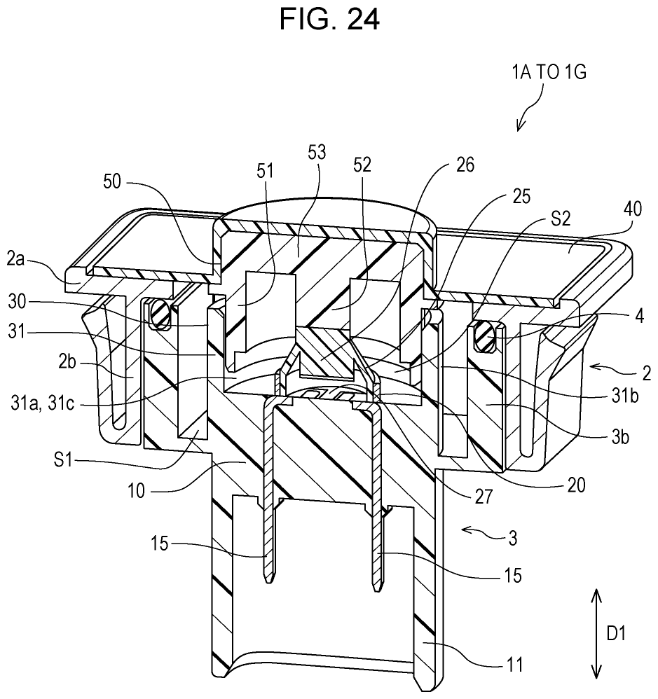

Each of FIGS. 23 and 24 is a sectional perspective view showing another example of mounting of the switch. Another example of mounting of the switch 20 is common to the switch devices 1A to 1G. In the example shown in FIG. 23, the switch 20 is directly connected to a connection terminal 15 embedded in the base 10. That is, in this configuration, the switch 20 is mounted on the base 10 without the substrate 101 (see FIG. 2) interposed therebetween and is conductively connected to the connection terminal 15.

In the example shown in FIG. 24, the rubber contact switch 20 is connected. The rubber contact switch 20 includes a dome portion 25 having elasticity such as elastomer, and a contact portion 26 provided on the dome portion 25. An electrode 27 is provided on the back face of the contact portion 26. When the contact portion 26 receives the pressing force from the operation portion 52, the dome portion 25 bends and the electrode 27 comes into contact with the two connection terminals 15 (or a pattern on the base 10 that is conductively connected to the connection terminal 15) provided at the base 10. This makes the two connection terminals 15 conductive. When the pressing force is released, the contact portion 26 is pushed back by the elastic restoring force of the dome portion 25, and the electrode 27 moves away from the two connection terminals 15 to be non-conductive. It is possible to use this type of rubber contact switch as the switch 20.

Thus, according to the present embodiment, it is possible to provide switch devices 1A to 1G that enable the stable operation, good operability, and can suppress damage to the operation portion 52.

The present embodiment is described above, but the present invention is not limited to these examples. For example, with respect to each of the above embodiments, those in which a person skilled in the art has appropriately added or deleted components, changed the design, or appropriately combined the features of the configuration examples of each embodiment are included in the scope of the present invention, as long as they embody the essence of the present invention.

What is claimed is:

1. A switch device comprising:
a base provided with a connection terminal to an outside;
a switch disposed at the base and connected to the connection terminal;
a guide member provided at the base and having a guide face for guiding the switch in a direction of an operation of the switch;
a flexible cover covering the switch and the guide member; and
a sliding member having a sliding portion held by the flexible cover and sliding on the guide face of the guide member and an operation portion of the switch.

2. The switch device according to claim 1, wherein each of the guide member and the sliding member is made of a resin material having flexibility less than flexibility of the flexible cover.

3. The switch device according to claim 1, wherein
the switch device has a regulation structure for regulating displacement of the sliding member toward the base in the operation direction, and wherein
a stop position of the sliding member by the regulation structure is set at a position where the operation portion is located closer to the base than to an on/off switching position of the switch.

4. The switch device according to claim 3, wherein
the sliding portion is located at an inner position relative to the guide member, and wherein
the sliding member has a sliding flange portion that contacts a contacted portion, of the guide member, different from the guide face at the stop position.

5. The switch device according to claim 3, wherein
the sliding portion is located at an outer position relative to the guide member, and wherein
a coupling portion connecting the sliding portion and the operation portion has a sliding contact portion that contacts a contacted portion, of the guide member, different from the guide face at the stop position.

6. The switch device according to claim 1, wherein
the guide member has a hollow tubular portion having an inner wall and an outer wall extending from the base in the operation direction, and wherein
the guide face is formed at one of the inner wall and the outer wall.

7. The switch device according to claim 1, wherein
the switch device includes a back portion including the base, the switch, and the guide member, and a front portion including the flexible cover and the sliding member, and wherein
the front portion and the back portion are fixed to each other.

8. The switch device according to claim 1, wherein
the switch device includes a light emitting unit inside the guide member and wherein
a coupling portion, of the sliding member, connecting the sliding portion and the operation portion includes a translucent portion that is allowed to transmit light from the light emitting unit.

9. The switch device according to claim 1, wherein
the sliding member includes a first member having the operation portion and a second member having the sliding portion and supported by the flexible cover, and wherein
the first member is fixed to the second member.
